(19) United States
(12) Patent Application Publication
(10) Pub. No.: US 2013/0133589 A1
(43) Pub. Date: May 30, 2013

(54) EDIBLE PET TOY

(71) Applicant: Brett J. Buchanan, Monroe, MI (US)

(72) Inventor: Brett J. Buchanan, Monroe, MI (US)

(21) Appl. No.: 13/749,598

(22) Filed: Jan. 24, 2013

Related U.S. Application Data
(63) Continuation of application No. 10/752,898, filed on Jan. 6, 2004, now abandoned.
(60) Provisional application No. 60/438,925, filed on Jan. 9, 2003.

(51) Int. Cl. A01K 11/00

(52) U.S. Cl. CPC A01K 15/026
USPC 119/710

(57) ABSTRACT

An edible pet toy. The pet toy is used for introducing a nutrient, treatment, and/or supplement component that benefits the health of the pet. The toy is manufactured entirely from a compressed substance or with a shell and at least one inner material. The toy can be either totally edible or includes a shell that is inedible yet expels one or more inner materials while the pet compresses the toy in its mouth.

### CROSS-REFERENCE TO RELATED APPLICATIONS

This application is a Continuation of pending Non-Provisional patent application Ser. No. 10/752,898, entitled “EDIBLE PET TOY”, and filed Jan. 6, 2004, which claims the benefit of U.S. Provisional Patent Application Ser. No. 60/438,925, entitled “EDIBLE PET TOY”, and filed Jan. 9, 2003.

### TECHNICAL FIELD

This invention is related to pet toys, and more specifically, to an edible pet toy.

### BACKGROUND OF THE INVENTION

The pet industry is a multi-billion dollar enterprise expanding to meet the needs of pet owners around the world who want ensure that their pets get the best care available. To meet such a need, there are stores devoted solely to pet food and pet care products. One such conglomerate is PetsMart, Inc., of Arizona, who boasts 2001 sales of $2.5 billion, as a leading provider of products, services, and solutions for the lifetime needs of pets. There are pet web sites, pet shows, pet cemeteries, pet doctors, magazines devoted solely to pets, and even software designed for the pet supplier to facilitate software and computer services to the animal health, veterinary, and pet industries.

Some pets require more “maintenance” then others. For example, properly caring for a cat is a vital service performed throughout the course of the feline's life. Cats are carnivores by nature requiring animal protein, or “meat”, to supply daily dietary protein requirements typically found in cat food that is made from beef, chicken, or fish. However, the costs associated with “proper” maintenance of the cat, as purported by the cat industry, can be prohibitive for many owners. Thus domesticated cats tend not to get the daily nutrition needs to maintain a healthy life. Coupled with the temperament associated with the cat as being an “independent” animal, it can be difficult to entice or encourage the cat to consume nutrients in a form other than the more expensive canned or dry food.

However, the need for a more convenient mechanism for introducing nutrients and medications is not limited to cats, but includes many other types of pets, e.g., dogs, ferrets, pigs, rodents, etc. Thus what is needed is an improved mechanism in the form of a pet toy that can provide nutrients or medications in an edible or partially edible form.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention disclosed and claimed herein, in one aspect thereof, comprises a pet toy for use in introducing a nutrient/treatment/supplement component that benefits the health of the pet. The toy is manufactured with an inner material and with or without a shell. The toy can be either totally edible or includes a shell that is inedible yet expels one or more inner materials while the pet compresses and/or disintegrates the toy in its mouth.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 illustrates a cutaway of an exemplary edible toy ball for a cat.

FIG. 2 illustrates a cutaway of an exemplary edible toy ball for a cat having an alternative layering structure.

FIG. 3 illustrates a cutaway of an exemplary edible toy ball for a pet having an alternative shape of a football and accompanying layering structure.

FIG. 4 illustrates a cutaway of an exemplary edible toy ball for a pet having a substantially spherical shape with nodules imposed thereon.

FIG. 5 illustrates a cutaway of an exemplary toy ball for a pet having a substantially spherical shape that is renewable for providing the nutrient/treatment/supplement component.

FIG. 6 illustrates a cross sectional view of an exemplary toy ball for a pet having a substantially spherical shape comprising a shell that includes therein one or more free-moving rattles.

FIG. 7 illustrates a cross sectional view of an exemplary toy ball for a pet having a substantially spherical shape comprising a shell that utilizes a plug through which the one or more free-moving rattles are inserted.

FIG. 8 illustrates a cross sectional view of an exemplary toy ball for a pet having a substantially spherical shape comprising a single material such as compressed catnip.

FIG. 9 illustrates a cross sectional view of an exemplary toy ball for a pet having a substantially spherical shape comprising a mixed materials such as compressed catnip, food, and nutrients.

FIG. 10 illustrates a flow chart of a method for providing an edible toy in accordance with the present invention.

FIG. 11 illustrates a flow chart of an alternative method for providing an edible toy in accordance with the present invention.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

The present invention identifies a need for providing a pet toy that not only provides entertainment for the pet, but can also be used to introduce a means of nourishment and/or enjoyment.

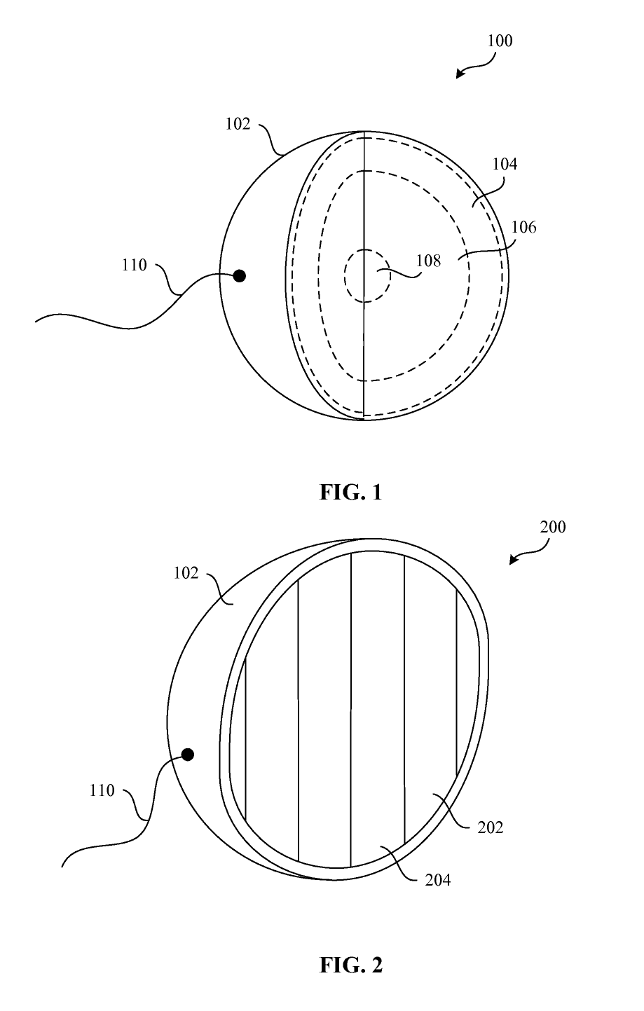

Referring now to FIG. 1, there is illustrated a cutaway of an exemplary edible toy ball 100 for a cat. In accordance with the present invention of providing nutrients and treats therein, the ball 100 is manufactured of mostly or entirely of a compressed food material, e.g., alfalfa, catnip (e.g., also an inducement that stimulates interaction), or similar substance. The ball 100 has an outer shell 102 that will gradually wear away during play or be chewed away as the cat attempts to chew or lick the toy 100. The shell 102 can consist of some essential oils (or edible product such as a food grade gelatin) to aid in the bonding/glazing process such that the shell 102 is relatively durable to resist manufacturing and handling processes and pet owner handling prior to exposure to the pet.

As illustrated, the toy 100 can be manufactured in a layered manner such that as overlying layers are worn away or penetrated, a fresh enticement in the form of a preferred food source is exposed so that the cat will continue to receive the enjoyment and nutrients contained therein. For example, the shell 102 is a relatively thin layer that encases the ball 100 to ensure freshness of the underlying layers of edible materials. The shell 102 need not contain an attractant such as catnip, since the rolling shape of the toy 100 will typically cause the cat to pounce and penetrate the shell with a biting or clawing action. Thus, all a cat owner or cat would need to do is roll or toss the toy 100 so that the cat is stimulated to make a first pounce (or contact) that causes penetration of the shell 102, which can also be to a first underlying layer 104. However, it is appreciated that the shell 102 can also include the attractant to further encourage the cat to pounce on the toy 100 in conjunction with or without rolling the toy 100.

Once the shell 102 is penetrated, the first underlying layer 104 is exposed to some extent, depending on the amount of material removed from or exposed through the shell 102. Since most cats are drawn to catnip, and catnip can lose its freshness if left exposed to over a long period of time, each underlying layer can contain a further composition of catnip and a nutrient/treat. The nutritional component can include a wide variety of supplements for the pet. Insofar as the pet in this particular embodiment is a cat, the nutrient/supplement component can include, but is not limited to cosequin, glycoflex and other joint supplements, skin and coat supplements, vitamins and antioxidants, laxatives and hairball treatments, high energy supplements, nutraceuticals, digestion and elimination supplements, food supplements, pain supplements, milk replacers, weight loss supplements, and dentifrices. The consistency of selected vitamins or other nutrient/supplements as ingredients can also double as filler or binding material. Of course, the amount of supplement/nutrient can be controlled in the manufacturing process of the toy 100 according to the size, age, type, and particular ailment of the animal. Thus, a cat owner who has a cat with skin and coat problems and a weight loss problem, for example, can purchase the toy 100 manufactured with only those components, or those components plus a few others that address the ailments or needs of the pet, and do not provide the treatments that are not required.

As the cat penetrates each underlying layer, fresh attractant is exposed to the cat's senses to entice or stimulate the cat to continue playing with the toy 100 and further penetrating underlying layers through biting, scratching, clawing, etc. Of course, since the attractant is also mixed in with layer binding material and nutrient/treatment/supplement component of each layer, further wearing away of overlying and already penetrated layer material will along with or separately from also expose fresh attractant such that the cat will be drawn to continue utilizing the toy 100.

In this particular embodiment, the toy includes a second underlying layer 106 of attractant mixed into the binding material plus a nutrient/treatment/supplement component. Finally, there is a core 108 comprising any single component or combination of the aforementioned component materials.

The binding material of any layer can include any material that is not detrimental to the health of the pet, and provides sufficient consistency to retain form yet slowly release the layer material once the layer is penetrated by the pet. This allows the toy 100 to be used repeatedly over a period of time. Of course, the toy 100 can be designed such that an underlying layer, for example, the second underlying layer 106, includes a gel, liquid or paste material that once penetrated by the pet, is consumed. However, further “play” with the toy 100 would then cause other underlying layers to be exposed so that the pet gains the benefit of additional components. Thus, the composition of the shell, binding materials, and components can be selected according to consistency and/or rigidity to extend the use of the toy (i.e., time release of the toy materials), such that wearing down or exposure of the desired materials by the pet is controlled. For example, the use of more liquids or gel materials in the layers reduces the lifetime of the toy 100 while providing the materials to the pet more quickly. Of course, allowing more rapid exposure to those layers by the pet allows the toy 100 to be either completely consumed more rapidly, or if not consumed, can lose its entertainment value or attractant feature, and thus need to be discarded sooner.

The toy 100 can also include a string 110 for suspending the toy, for example, or can include edible additions functioning as a further enticement to the pet to play with the toy (such as edible eyes, ears or a tail (mouse) or figures/additions enticing to a particular animal), and ultimately penetrate the shell 102. The string 110 can be made of standard string material, elastic material or an edible material, so that when the toy 100 is released after extending the elastic string 110, further movement of the toy 100 is provided. The string 110 can also be used to reduce rolling of a substantially round or rollable toy 100. Moreover, if the string 110 is pulled out of the shell 102 of the toy 100, this facilitates exposing underlying material to further stimulate the pet to play with the toy 100.

Referring now to FIG. 2, there is illustrated a cutaway of an exemplary edible toy ball 200 for a cat having an alternative layering structure. Here the particular layering structure facilitates allowing the pet to gain access to the component material of each layer as the shell 102 is penetrated. Thus it is possible for the pet to access any number of layer materials of any number of layers, e.g., in both layers 202 and 204, by penetrating the shell 102 in those areas. Of course, the core material 108 of FIG. 1 (not shown in FIG. 2) could be inserted as a core in the toy ball 200. The toy 200 can also include one or more of the strings 110 indicated in FIG. 1.

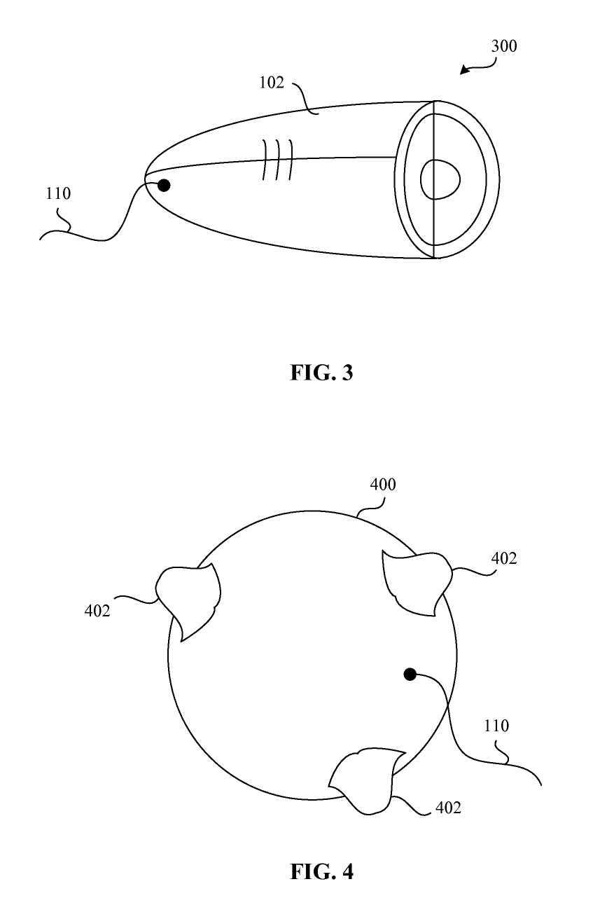

Referring now to FIG. 3, there is illustrated a cutaway of an exemplary edible toy ball 300 for a pet having an alternative shape of a football and accompanying layering structure. The same layering principles and layer components apply to the ball 300 as in the ball 100 of FIG. 1, and layering of the ball 200 of FIG. 2. The ball 300 is shaped thus to facilitate attracting attention from a pet that gravitates to objects that move or roll. Thus the ball 300 will move or rock once touched, encouraging the pet to continue to contact the ball 300 to ultimately penetrate the shell 102. Of course, the attractant embedded therein, if employed at all, according of the particular pet, or treat provided therein, will function to continue to attract the pet to the toy 300 to gain the benefit of underlying nutrients and treats. The toy 300 can also include the string 110 for suspending or providing a further enticement to the pet to contact the toy 300 (or other edible attached additions disclosed herein).

Referring now to FIG. 4, there is illustrated a cutaway of an exemplary edible toy ball 400 for a pet having a substantially spherical shape with nodules 402. The contents and layer components of the ball 400 can be employed in essentially the same manner as described in previous toys 100, 200, and 300. However, the ball 400 includes the one or more nodules 402 that can provide a separate nutrient/treatment/supplement component when penetrated. The use of the nodules 402 also facilitates the ball 400 rolling in more unusual ways enticing the pet to continue contact therewith. The toy 400 can also include the string 110. It is to be appreciated that not only can the nodules 402 provide different materials for consumption, but breakaway of a nodule 402 from the shell of the ball 400, further exposes shell material for consumption by the pet and/or stimulation of the pet for further contact. The nodules 402 (and the string 110) also allow the pet to more effectively grasp or interact with the toy 400.

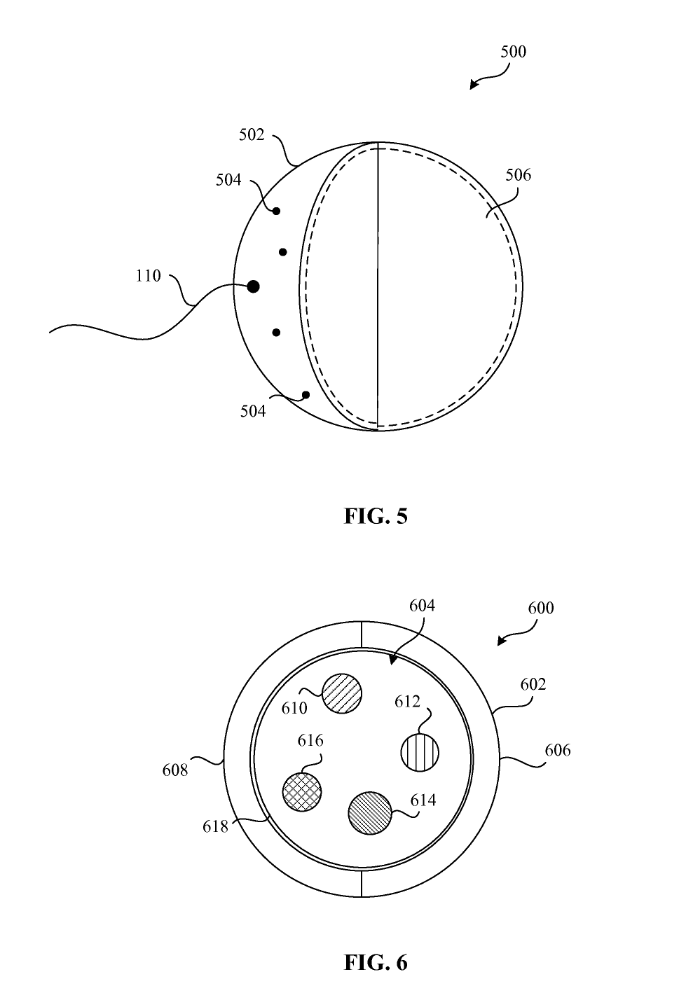

Referring now to FIG. 5, there is illustrated a cutaway of an exemplary toy ball 500 for a pet having a substantially spherical shape that is renewable (or reusable) for providing the nutrient/treatment/supplement component. The toy 500 is renewable in that a shell 502 is made of a durable inedible material. The shell 502 has one or more minute holes, orifices or cavities 504 manufactured therein that expel inner liquid, gel, or paste component material 506 once the jaw of the pet compresses the ball 500, or the pet in some way compresses or deforms the natural shape of the shell 502. In an alternative implementation, the inner material is exposed in response to the pet simply rolling or moving the ball 500. This ball 500 is preferable for use with dogs or other animals that need little or no enticement to put something into their mouth, but can then be retrieved for reuse by re-injecting and/or coating the ball 500 with the same or some other inner component material 506. The ball 500 can include the string 110 and/or nodules 402, for example, for use as described hereinabove. For example, the nodules 402 can be manufactured in a rigid, but edible format, such that the nodules 402 can be inserted in one of the minute holes. When the pet mouths or chews the toy 500, the nodules 402 can be suitably designed to breakaway as a separate treat for consumption. Such nodules can then be purchased separately for use in combination with the internal materials, or separately without using the internal material(s).

Referring now to FIG. 6, there is illustrated a cross sectional view of an exemplary toy ball 600 for a pet having a substantially spherical shape comprising a shell 602 that includes therein one or more free-moving rattles (or pellets) 604. The shell 602 is comprised of two hemispherical halves or gores (606 and 608) that mate to seal the treats therein. The shell halves (606 and 608) can be bonded together utilizing an edible bonding material such as gelatin. Thus the ball 600 becomes essentially a rattle with a mixed number of components sealed internal to the shell halves (606 and 608). The shell halves (606 and 608) can be a single composition of compressed material, a mixed composition of compressed material, or a shelled structure, for example. The amount of compression to be used is determined by how long the ball 600 (and any previously disclosed balls or toys) is desired to be in use before the animal is allowed to reach the next inner layer or internal compartments. For example, a treat for a larger or stronger cat (or animal) may have a greater compression parameter so that the animal does not gain access to the underlying layers or treats very quickly. However, the compression parameter should not be too great such that the animal loses interest when unable to be stimulated when prevented from gaining access to the underlying layers or treats in a reasonable amount of time. Such parameter can be determined on a pet-by-pet basis, toy-by-toy basis, and according to the animal size.

In this particular embodiment, the toy 600 includes four different types of internal rattles 604. The number, size, and composition of the rattles can be different or the same or any combination thereof. A first rattle 610 includes a mixture of more than one material. A second rattle 612 includes a mixture of food materials. A third rattle 614 comprises catnip (where a cat is involved). A fourth rattle 616 contains a nutrient material. The rattles 604 need not be spherical in shape, but can be any shape since once the animal gains access to the interior of the toy 600, the rattle will likely be consumed.

It is contemplated that a nutrient or material in the form of a gelatin capsule may also be inserted into the ball 600 for eventual consumption by the pet. In another implementation, there is provided the outer shells (606 and 608) which are now inedible, and an inner gelatin type shell 618 that would rupture with pressure or biting for release of the inner material (like a gel material or relatively heavy liquid similar to the consistency of Vitamin E) to the animal. In this way, the inedible outer shell (606 and 608) can be reused by washing it out and the inner gelatin-type capsule shell 618 dissolved by the consumer and/or thrown away and then replaced.

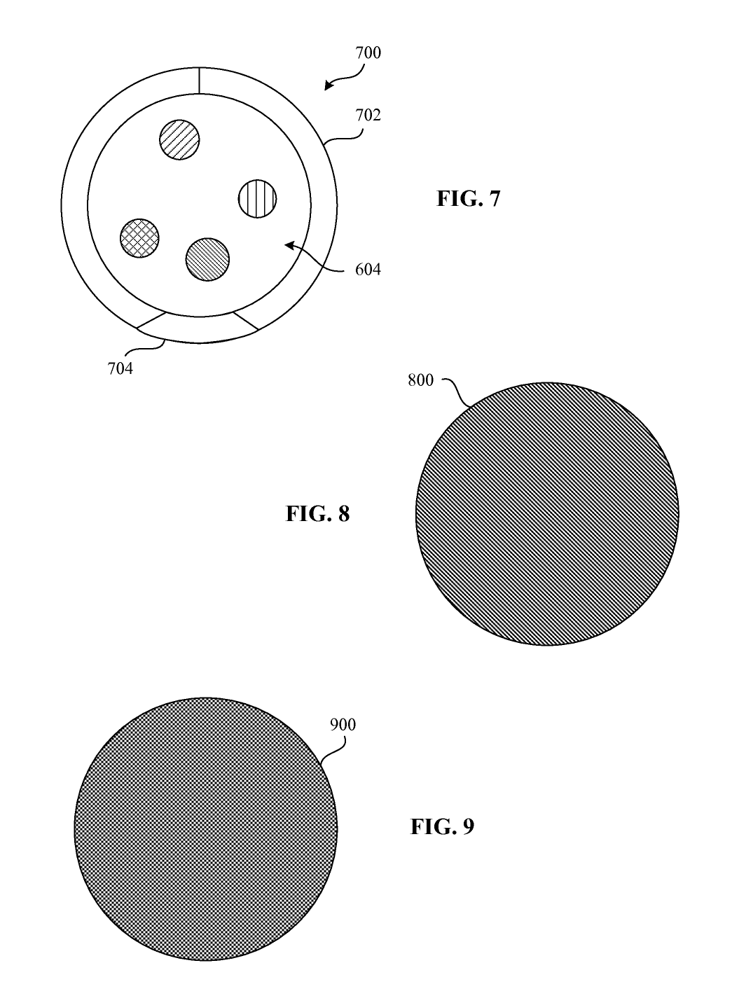

Referring now to FIG. 7, there is illustrated a cross sectional view of an exemplary toy ball 700 (similar to the toy 600) for a pet having a substantially spherical shape comprising a shell 702 that utilizes a plug 704 through which the one or more free-moving rattles 604 are inserted. The shell 702 can be composed of a single material composition such as catnip (where a cat is involved), or other suitable enticing material for the particular animal. The toy 700 includes the rattles 604 of FIG. 6, although the number, shape, size, and composition can vary. The plug 704 can be made of a single or mixed material, curved to match the surface design of the toy 700. The plug 704 can be drilled out for insertion by the manufacturer of the various rattles 604, and then glued back into place utilizing a suitable edible bonding material, or a material that is not harmful to the animal. Thus the customer can reuse the toy by removing the plug 704, inserting the same or different material, and replacing the plug 704. The plug need not match the curvature of the toy thereby facilitating easier handling by the owner. For example, a conical plug that the owner can easily grab, or some other type of design to allow it to turn and lock into place (such as with a screwdriver) is also contemplated.

Referring now to FIG. 8, there is illustrated a cross sectional view of an exemplary solid toy ball 800 for a pet having a substantially spherical shape comprising a single material such as compressed catnip.

Referring now to FIG. 9, there is illustrated a cross sectional view of an exemplary solid toy ball 900 for a pet having a substantially spherical shape comprising mixed materials such as compressed catnip, food, and nutrients.

Note that the aforementioned toys are not limited to cats, or dogs, but have application with many other types of pets. For example, ferrets, pigs, rodents, birds, etc., and virtually any type of pet that normally would find interest or have an interest created in such objects.

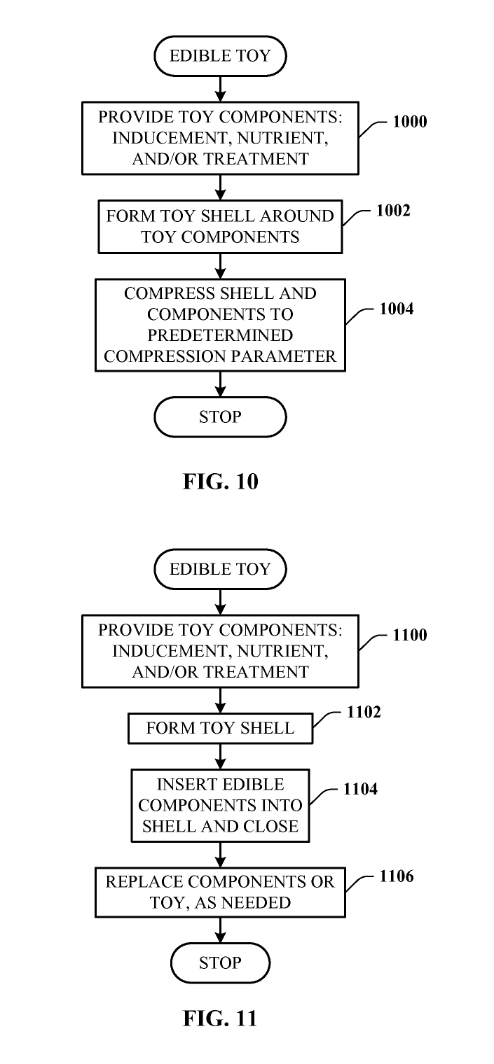

Referring now to FIG. 10, there is illustrated a flow chart of a method for providing an edible toy in accordance with the present invention. While, for purposes of simplicity of explanation, the one or more methodologies shown herein, e.g., in the form of a flow chart, are shown and described as a series of acts, it is to be understood and appreciated that the present invention is not limited by the order of acts, as some acts may, in accordance with the present invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

At 1000, components of the edible toy are provided in the desired consistency, and combination of components. For example, the components can include at least an inducement (e.g., catnip, for a cat), a nutrient, and a treatment. At 1002, a shell is formed around the component(s). The shell can be created using a shell tool shaped in the form of the toy, e.g., a ball. Thus, when the components are compressed using the shell tool, the resulting toy matches the shape of the tool. In this scenario, the edible toy may not necessarily have a separate shell, wherein a cross-section of the toy would reveal a distinctive layer that discerns where the shell ends and the inner portion of the edible toy begins, but the edible toy is then one substantially homogeneous material, although homogeneity is not a requirement either. The consistency can also provide a “marbling” effect of the components throughout the toy where the presence of one component is significantly more than another component at a given location. At 1004, the components are compressed in the tool to form the edible toy. The process then reaches a Stop block.

Referring now to FIG. 11, there is illustrated a flow chart of an alternative method for providing an edible toy in accordance with the present invention. At 1100, components of the edible toy are provided in the desired consistency, and combination of components. At 1102, the shell is formed. At 1104, one or more of the components can be pre-shaped into smaller objects that can be captured in the interior of the toy, and later replaced, after having been consumed or worn out. Moreover, where the component is a gel or liquid, insertion can be via a hole that is capped off. At 1106, the objects, gel, and/or liquid can be replaced as it is consumed or after it has been consumed such that the toy can be made totally consumable or reusable. Flow then reaches a Stop block.

It is to be appreciated that numerous types of shells can be employed to facilitate holding or capturing the edible materials while also providing a means for allowing the edible materials to be released to the pet. For example, a hard shell structured of a grated plastic can be used for compressing the inner materials. Alternatively, the shell comprises two mating hemispheres, where one or both plastic hemispheres include many holes (e.g., similar to a plastic WIFFLE ball). Each half can then be placed into a respective die halves into which the inner material is placed and compressed to form a hard plastic outer structure with a compressed matrix of material that extrudes through the holes when compressed. Of course, various other structures can be used inside in accordance with other embodiments describer hereinabove.

Compressive pressures employed in accordance with the present invention range in one embodiment from approximately 1000 to 2000 psi. In a second embodiment, the pressure ranges from approximately 1200 to 1800 psi, and in a third embodiment, the pressure ranges from approximately 1400 to 1600 psi.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A toy for an animal, comprising:
a shell shaped to enable oral interaction by the animal; and
one or more free-moving rattles contained within the shell, the one or more free-moving rattles comprise an edible material.

2. The toy of claim 1, wherein the shell is composed of two halves that mate to enclose the one or more rattles therein.

3. The toy of claim 2, wherein the two halves are bonded together utilizing an edible material.

4. The toy of claim 1, wherein the shell comprises a removable plug for insertion of the one or more rattles.

5. The toy of claim 1, wherein the one or more rattles are of different edible materials that include a nutrient and a food material.

6. The toy of claim 1, wherein the shell is made of an inedible and reusable material and the shell can be opened.

7. The toy of claim 1, wherein the shell encompasses an inner shell that ruptures under pressure for release of an inner material.

8. The toy of claim 1, wherein the shell is compressed during manufacture to a compression parameter for a particular animal such that a lower compression parameter facilitates easier access to the edible material and a higher compression parameter facilitates more difficult access to the edible material.

9. A toy for an animal, comprising:
a shell of a shape that enables oral interaction by the animal, the shell having an accessible interior; and
an edible and free-moving material enclosed in accessible interior of the shell, the shell can be opened for insertion of the edible and free-moving material and replacement of the edible and free-moving material.

10. The toy of claim 9, wherein the edible and free-moving material comprise one or more rattles are of different edible materials, which include a nutrient.

11. The toy of claim 9, wherein the shell is made of an inedible and reusable material.

12. The toy of claim 9, wherein the shell comprises a removable plug for access to the interior.

13. The toy of claim 9, wherein the shell comprises one or more holes via which the free-moving material is released under pressure applied by the oral interaction of the animal.

14. The toy of claim 9, wherein the edible and free-moving material comprises at least one of a liquid, a gel, a paste, or an edible object that moves freely within the shell.

15. An toy for an animal, comprising:
a shell of a shape that enables oral interaction by the animal, the shell having an accessible interior in which a free-moving material is enclosed, the shell can be opened for insertion of the free-moving material and replacement of the free-moving material.

16. The toy of claim 15, wherein the free-moving material includes an inducement that stimulates the animal, which is a cat, to interact therewith.

17. The toy of claim 15, wherein the free-moving material comprises one or more rattles of different edible materials the move freely in the interior.

18. The toy of claim 15, wherein the shell is composed of two halves that mate and are bonded together using an edible material.

19. The toy of claim 15, wherein the shell is spherical and includes a plug that can be removed to expose the accessible interior for insertion of the free-moving material and replacement of the free-moving material after being consumed.

20. The toy of claim 15, wherein the free-moving material is a gel that is forced through the shell when pressure is applied to the toy.
